(19) United States
(12) Patent Application Publication
(10) Pub. No.: US 2023/0219522 A1
(43) Pub. Date: Jul. 13, 2023

(54) METHOD FOR MONITORING INTERNAL ENVIRONMENT OF VEHICLE, ELECTRONIC DEVICE, AND STORAGE MEDIUM

(71) Applicant: HON HAI PRECISION INDUSTRY CO., LTD., New Taipei (TW)

(72) Inventor: LIANG-TE CHIU, New Taipei (TW)

(21) Appl. No.: 18/097,075

(22) Filed: Jan. 13, 2023

(30) Foreign Application Priority Data
Jan. 13, 2022 (CN) 202210039466.7

(51) Int. Cl. B60R 25/102; G06V 20/59; G06V 40/16; B60R 25/25; B60R 25/30

(52) U.S. Cl. CPC B60R 25/102; G06V 20/59; G06V 40/16; B60R 25/25; B60R 25/305; B60R 2025/1016

(57) ABSTRACT

A method for monitoring internal environment of a vehicle implemented in an electronic device includes detecting environment data of internal of the vehicle, and detecting whether an engine of the vehicle is running; when the engine of the vehicle is running and the environment data does not meet a preset threshold, issuing a first alarm; when the engine of the vehicle is not running, obtaining location information of the vehicle, activating a camera device to capture images or shoot a video of internal of the vehicle, and determining whether at least one living creature is inside the vehicle; when the at least one living creature is inside the vehicle, transmitting the location information, and the images or the video and the environment data to a terminal device; and displaying the location information, the images or the video and the environment data, and issuing a second alarm.

### FIELD

The subject matter herein generally relates to vehicles security, and particularly to an electronic device, a method for monitoring internal environment of a vehicle, and a storage medium.

### BACKGROUND

Vehicles in private ownership are used by people for their own purposes, and driving safety is important. At present, safety inside the vehicle when the vehicle is parked or while driving is often no considered.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an embodiment of application environment of a method for monitoring internal environment of a vehicle according to the present disclosure.

FIG. 2 illustrates a flowchart of an embodiment of a method for monitoring internal environment of a vehicle according to the present disclosure.

FIG. 3 is a block diagram of an embodiment of an electronic device according to the present disclosure.

### DETAILED DESCRIPTION

Multiple embodiments are described in the present disclosure, but the description is exemplary rather than limiting, and there may be more embodiments and implementation solutions within the scope of the embodiments described in the present disclosure. Although many possible combinations of features are shown in the drawings and discussed in the detailed description, many other combinations of the disclosed features are also possible. Unless specifically limited, any feature or element of any embodiment may be used in combination with or in place of any other feature or element of any other embodiment.

When describing representative embodiments, the specification may present methods and/or processes as a specific sequence of steps. However, to the extent that the method or process does not depend on the specific order of steps described in the present disclosure, the method or process should not be limited to the specific order of steps described. As understood by those of ordinary skills in the art, other orders of steps are also possible. Therefore, the specific order of steps set forth in the specification should not be interpreted as limitation to the claims. In addition, the claims for the method and/or process are not be limited to the steps performed in the written order, and those of skill in the art may readily understand that this order may vary and still remain within the essence and scope of the embodiments of the present disclosure.

Unless otherwise defined, technical terms or scientific terms used in the embodiments shall have common meanings as construed by those of ordinary skills in the art to which the present disclosure pertains. The terms “first”, “second” and the like used in the embodiments of the present disclosure do not represent any order, quantity, or importance, but are merely used to distinguish different components. The terms “include”, “contain” or the like mean that elements or articles appearing before such terms cover elements or articles listed after the words and their equivalents without excluding other elements or articles. The terms “connect”, “link” or the like are not limited to physical or mechanical connection, but may include electrical connections, whether direct or indirect.

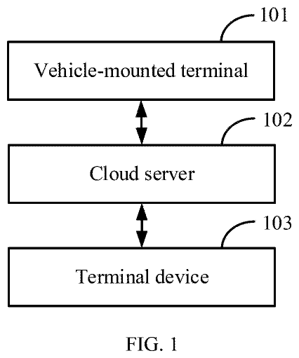

Referring to FIG. 1, a method for monitoring internal environment of a vehicle is applied in a vehicle-mounted terminal 101, a cloud server 102, and a terminal device 103. In one embodiment, the vehicle-mounted terminal 101 is arranged in a vehicle, and is used to detect the environment inside the vehicle and obtain the environment data inside the vehicle, and to detect whether the engine of the vehicle is running. If the engine is running and the environment data inside the vehicle does not meet a preset threshold, a first alarm is issued. The first alarm includes, but is not limited to, outputting a voice prompt warning a user to ventilate or apply cooling inside the vehicle.

If the engine of the vehicle is not running, location information of the vehicle is obtained and an internal camera device is activated to capture images or shoot a video inside the vehicle, and the presence or absence of living creatures inside the vehicle is determined based on the images or video, by the vehicle-mounted terminal 101. If the presence of living creatures inside the vehicle is determined, that is, the at least one living creature is inside the vehicle, the vehicle-mounted terminal 101 transmits the location information, the images or video, and the environment data inside the vehicle to the terminal device 103 through the cloud server 102.

The vehicle-mounted terminal 101 can further determine whether at least one human is inside the vehicle by recognizing the images or video inside the vehicle according to a biometric recognition method, if the at least one human is determined to be inside the vehicle, obtain the face image of the at least one human from the images or video inside the vehicle, compare the face image with a plurality of face images prestored in a database, and issue an alarm for theft if the face image cannot does not match any of the plurality of face images prestored in the database. If the face image matches at least one of the plurality of face images and the environment data inside the vehicle does not meet the preset threshold, an alarm for help is issued. If the similarity between the face image and the image prestored in the database is greater than a preset percentage, it is determined that the face image matches the image prestored in the database. The preset percentage can be ninety percent. The biometric recognition method is prior art, which is not described in detail.

According to the biometric recognition method, if it is determined that the at least one animal is determined to be inside the vehicle and the environment data inside the vehicle does not meet the preset threshold, the alarm for help is also issued. The alarm for help and the alarm for theft are a second alarm.

The cloud server 102 is used to store contact information of the vehicle user and related emergency contacts of the vehicle user, store the images or video obtained by the internal camera device, receive the location information, the images or video of internal of the vehicle, and the environment data inside the vehicle transmitted by the vehicle-mounted terminal 101, and transmit the location information, the images or video and the environment data of internal of the internal of the vehicle to the terminal device 103.

The terminal device 103 can display the images or video of internal of the vehicle, the location information, the living creature inside the vehicle, and the environment data of internal of the vehicle, receive a first user operation, and issue an alarm for theft in response to the first user operation. The alarm for theft can include, but is not limited to, reporting to the Police. The terminal device 103 can further receive a second user operation, and control the vehicle to issue an alarm for help in response to the second user operation, the alarm for help includes, but is not limited to, controlling the vehicle to emit sound, such as sound horn. The terminal device 103 can be a mobile device, such as a mobile phone.

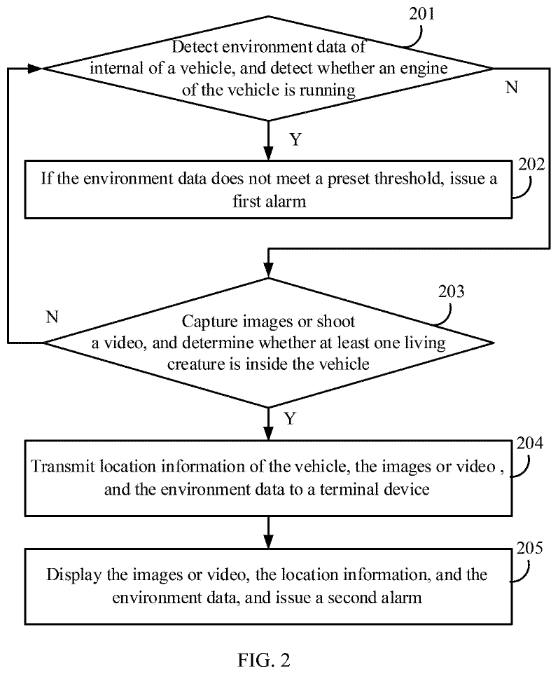

FIG. 2 illustrates a flowchart of an embodiment of a method for monitoring internal environment of a vehicle. The method is provided by way of example, as there are a variety of ways to carry out the method. Each block shown in FIG. 2 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 201.

At block 201, detecting environment data of internal of the vehicle, and detecting whether the engine of the vehicle is running.

In one embodiment, the environment data of internal of the vehicle includes, oxygen concentration, carbon dioxide concentration, carbon monoxide concentration, and temperature. In one embodiment, the vehicle-mounted terminal 101 controls an oxygen sensor to detect the oxygen concentration inside the vehicle, controls a carbon dioxide sensor to detect the carbon dioxide concentration inside the vehicle, controls a carbon monoxide sensor to detect the carbon monoxide concentration inside the vehicle, and controls a temperature sensor to detect the temperature inside the vehicle.

In one embodiment, the vehicle-mounted terminal 101 detects whether a tachometer on an instrument panel of the vehicle is recording a “0”engine speed, and if the tachometer points to “0” engine speed, it is determined that the engine is not running, if the tachometer does not point to “0” engine speed, it is determined that the engine is running .

At block 202, if the environment data of internal of the vehicle does not meet a preset threshold, issuing a first alarm.

In one embodiment, if the vehicle-mounted terminal 101 detects that the tachometer does not point to “0” engine speed, it is determined that the engine of the vehicle is running.

In one embodiment, when the vehicle-mounted terminal 101 determines that the engine is running, the vehicle-mounted terminal 101 determines whether an oxygen concentration is less than a first preset threshold, determines whether a carbon dioxide concentration is greater than a second preset threshold, determines whether a carbon monoxide concentration is greater than a third preset threshold, and determines whether a temperature is greater than a fourth preset threshold. If the vehicle-mounted terminal 101 determines that the oxygen concentration is less than a first preset threshold, and/or determines that the carbon dioxide concentration is greater than a second preset threshold, and/or determines that the carbon monoxide concentration is greater than a third preset threshold, and/or determines that the temperature is greater than a fourth preset threshold, the vehicle-mounted terminal 101 issues the first alarm for warning the driver that ventilation or cooling is required, which ensures the safety of living creatures inside the vehicle.

At block 203, obtaining the location information of the vehicle, activating the camera device inside the vehicle to capture images or shoot a video of the internal of the vehicle, and determining whether at least one living creature is inside the vehicle based on the images or video of the internal of the vehicle.

In one embodiment, when the vehicle-mounted terminal 101 detects that the engine of the vehicle is not running, the vehicle-mounted terminal 101 obtains the location information by a Global

Position System (GPS) of the vehicle, and activates the camera device to capture the images or record a video of the internal of the vehicle.

In one embodiment, the living creature can be a human or an animal, the vehicle-mounted terminal 101 determine whether at least one human or animal is inside the vehicle by recognizing and analyzing the images or video of the internal of the vehicle using the biometric recognition method.

At block 204, transmitting the location information, and the images or video and the environment data of the internal of the vehicle, to the terminal device 103 through the cloud server 102.

In one embodiment, if the presence of at least one living creature is detected by using the biometric recognition method, the vehicle-mounted terminal 101 transmits the environment data of the internal of the vehicle and the location information to the cloud server 102 through at least one communication method of a mobile network, BLUETOOTH, or WI-FI. The cloud server 102 stores the information transmitted by the vehicle-mounted terminal 101, and transmits the information transmitted by the vehicle-mounted terminal 101 to the terminal device 103 of the vehicle user and related emergency contacts based on the contact information of the vehicle user and related emergency contacts stored in the cloud server 102.

In one embodiment, the terminal device 103 of the vehicle user or an emergency contact displays the location information, the images or video and the environment data of the internal of the vehicle transmitted by the cloud server 102.

In one embodiment, when the vehicle-mounted terminal 101 determines that the at least one human is inside the vehicle according to the biometric recognition method, the vehicle-mounted terminal 101 compares the face image with a plurality of face images in the database. If the face image does not match any face image in the database, the vehicle-mounted terminal 101 issues the alarm for theft, the theft alarm includes, but is not limited to, reporting to the Police. When the alarm for theft is issued, the location information is transmitted to the Police for catching the thief quickly.

When the vehicle-mounted terminal 101 determines that the at least one human is inside the vehicle according to the biometric recognition method, the vehicle-mounted terminal 101 compares the face image with the plurality of face images in the database. If the face image matches at least one face image in the database, and the environment data of the internal of the vehicle the vehicle does not meet the preset threshold, the vehicle-mounted terminal 101 issued the alarm for help, the alarm for help includes, but is not limited to, the vehicle honking continuously. It should be noted that the continuous honking of the vehicle can attract the attention of passers-by, so that the passers-by can provide assistance and achieve the effect of eliminating a crisis.

In one embodiment, if the vehicle-mounted terminal 101 determines that the oxygen concentration is less than the first preset threshold, and/or determines that the carbon dioxide concentration is greater than the second preset threshold, and/or determines that the carbon monoxide concentration is greater than the third preset threshold, and/or determines that the temperature is greater than the fourth preset threshold, the environment data of the internal of the vehicle is determined as not meeting the preset threshold.

In one embodiment, the vehicle-mounted terminal 101 further issues the alarm for help when it is determined that a pet or other animal in the vehicle and the environment data of the internal of the vehicle does not meet the preset threshold.

At block 205, displaying the location information, the images or video and the environment data of the internal of the vehicle, and issuing a second alarm in response to a user operation.

In one embodiment, when the terminal device 103 receives the location information, the images or video and the environment data of the internal of the vehicle transmitted by the cloud server 102, the terminal device 103 activates the display device, and displays the location information, and the images or video and the environment data of the internal of the vehicle on the display device, the images or video displayed on the display device includes the image of living creature inside the vehicle. When the terminal device 103 receives the information transmitted by the cloud server 102, the terminal device 103 directly display the information on the display device. In detail, the terminal device 103 activates the display device and displays a prompt on the display device for the received emergency information, or directly displays the information (e.g., at least one category of the location information, and the images or video and the environment data of the internal of the vehicle) on the display device, and a voice prompt can also be issued to warn the user to check the information as soon as possible.

The terminal device 103 receives the first user operation, and issues the alarm for theft in response to the first user operation. The alarm for theft includes, but is not limited to, reporting to the Police. When the alarm for theft is issued, the location information is transmitted to the Police. The terminal device 103 receives the second user operation, and controls the vehicle to issue the alarm for help in response to the second user operation, the alarm for help includes, but is not limited to, the vehicle honking continuously. The vehicle receives the alarm for help and continuously emits sound, and the continuous sounds of the vehicle can attract the attention of passers-by for help, so as to achieve the effect of eliminating the crisis.

In one embodiment, when the vehicle-mounted terminal 101 determines that the at least one human or animal is inside the vehicle according to the biometric recognition method, and the environment data of the internal of the vehicle does not meet the preset threshold, the terminal device 103 receives a third user operation, and transmits a control instruction to the vehicle-mounted terminal 101 in response to the third user operation. When the vehicle-mounted terminal 101 receives the control instruction from the terminal device 103, the vehicle-mounted terminal 101 controls the vehicle to open a sunroof or activate an air conditioner system, thus, the vehicle is ventilated and the temperature inside the vehicle is reduced, so as to achieve the effect of eliminating the crisis.

It should be noted that, when the engine of the vehicle is not running, the backup battery of the vehicle or the battery of the vehicle provides power for the vehicle-mounted terminal 101, which ensure that the vehicle can also perform detection, wireless communication, and control operations even if the engine is not running. In one embodiment, the backup battery may be a rechargeable battery, the rechargeable battery can be a lithium matrix battery, a nickel-chromium battery, and a nickel-metal hydride battery.

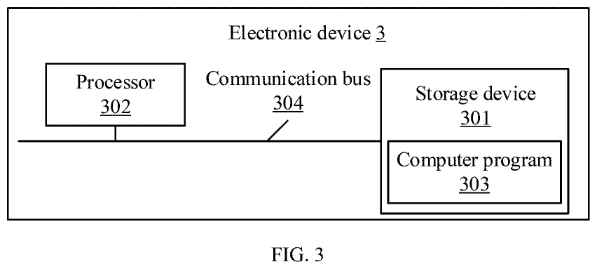

FIG. 3 illustrates the electronic device 3 in one embodiment. The electronic device 3 can be the vehicle-mounted terminal 101. The electronic device 3 includes, but is not limited to, a storage device 301, a processor 302, a computer program 303, and a communication bus 304. FIG. 3 illustrates only one example of the electronic device 3. Other examples can include more or fewer components than as illustrated or have a different configuration of the various components in other embodiments.

The processor 302 can be a central processing unit (CPU), a microprocessor, or other data processor chip that performs functions in the electronic device 1.

In one embodiment, the storage device 301 can include various types of non-transitory computer-readable storage mediums. For example, the storage device 301 can be an internal storage system, such as a flash memory, a random access memory (RAM) for the temporary storage of information, and/or a read-only memory (ROM) for permanent storage of information. The storage device 301 can also be an external storage system, such as a hard disk, a storage card, or a data storage medium.

The storage device 301 stores instructions, the processor 302 executes the computer program 303 stored in the storage device 301 for implementing the method for monitoring internal environment of a vehicle provided in the embodiments of the present disclosure. The computer program 303 is a monitoring program and includes instructions.

Upon execution of the instructions stores in the storage device 301, the processor 302 is configured to:

detect environment data of internal of the vehicle, and detecting whether the engine of the vehicle is running;

if the environment data of internal of the vehicle does not meet a preset threshold, issue a first alarm;

obtain the location information of the vehicle, activate the camera device inside the vehicle to capture images or shoot a video of the internal of the vehicle, and determine whether at least one living creature is inside the vehicle based on the images or video of the internal of the vehicle;

transmit the location information, and the images or video and the environment data of the internal of the vehicle, to the terminal device 103 through the cloud server 102;

display the location information, the images or video and the environment data of the internal of the vehicle, and issue a second alarm in response to a user operation.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. A method for monitoring internal environment of a vehicle implemented in an electronic device comprising:
detecting environment data of internal of the vehicle, and detecting whether an engine of the vehicle is running;
in response that the engine of the vehicle is running and the environment data does not meet a preset threshold, issuing a first alarm;
in response that the engine of the vehicle is not running, obtaining location information of the vehicle, activating a camera device inside the vehicle to capture images or shoot a video of internal of the vehicle, and determining whether at least one living creature is inside the vehicle based on the images or video of the internal of the vehicle;
in response that the at least one living creature is inside the vehicle, transmitting the location information, and the images or the video and the environment data of the internal of the vehicle to a terminal device; and
displaying the location information, the images or the video and the environment data of the internal of the vehicle, and issuing a second alarm in response to a user operation.

2. The method according to claim 1, wherein the environment data comprises an oxygen concentration, a carbon dioxide concentration, a carbon monoxide concentration, and a temperature.

3. The method according to claim 1, wherein determining whether at least one living creature is inside the vehicle based on the images or video of the internal of the vehicle comprises:
analyzing the images or video of the internal of the vehicle by using a biometric recognition method.

4. The method according to claim 1, wherein issuing a second alarm in response to a user operation comprises:
receiving a first user operation, and issuing an alarm for theft in response to the first user operation; and
receiving the second user operation, and controlling the vehicle to issue an alarm for help in response to the second user operation.

5. The method according to claim 4, further comprising:
in response that at least one human is inside the vehicle by the biometric recognition method, obtaining a face image of the at least one human from the images or video inside the vehicle, comparing a face image of the at least one human with a plurality of pre-stored face image, and determining whether the face image matches at least one pre-stored face image;
in response that the face image does not match any pre-stored face image, issuing the alarm for theft; and
in response that the face image matches at least one pre-stored face image and the environment data of the internal of the vehicle does not meet the preset threshold, issuing the alarm for help.

6. The method according to claim 5, further comprising:
in response that at least one animal is determined to be inside the vehicle by the biometric recognition method, and the environment data of the internal of the vehicle does not meet the preset threshold, issuing the alarm for help.

7. The method according to claim 2, wherein in response that the engine of vehicle is running and the environment data of internal of the vehicle does not meet a preset threshold, issuing a first alarm comprises:
in response that the oxygen concentration is less than a first preset threshold, and/or the carbon dioxide concentration is greater than a second preset threshold, and/or the carbon monoxide concentration is greater than a third preset threshold, and/or the temperature is greater than a fourth preset threshold, issuing the first alarm.

8. An electronic device comprising:
at least one processor; and
a storage device coupled to the at least one processor and storing instructions for execution by the at least one processor to cause the at least one processor to:
detect environment data of internal of the vehicle, and detecting whether an engine of the vehicle is running;
in response that the engine of the vehicle is running and the environment data inside the vehicle does not meet a preset threshold, issue a first alarm;
in response that the engine of the vehicle is not running, obtain location information of the vehicle, activate a camera device inside the vehicle to capture images or shoot a video of internal of the vehicle, and determine whether at least one living creature is inside the vehicle based on the images or video of the internal of the vehicle;
in response that the at least one living creature is inside the vehicle, transmit the location information, and the images or the video and the environment data of the internal of the vehicle to a terminal device; and
display the location information, the images or the video and the environment data of the internal of the vehicle, and issuing a second alarm in response to a user operation.

9. The electronic device according to claim 8, wherein the environment data comprises oxygen concentration, carbon dioxide concentration, carbon monoxide concentration, and temperature.

10. The electronic device according to claim 8, wherein the at least one processor is further caused to:
determine whether the at least one living creature is inside the vehicle by analyzing the images or video of the internal of the vehicle by a biometric recognition method.

11. The electronic device according to claim 8, wherein the at least one processor is further caused to:
receive a first user operation, and issue an alarm for theft in response to the first user operation; and
receive the second user operation, and control the vehicle to issue an alarm for help in response to the second user operation.

12. The electronic device according to claim 11, wherein the at least one processor is further caused to:
in response that at least one human is inside the vehicle by the biometric recognition method, obtaining a face image of the at least one human from the images or video inside the vehicle, comparing a face image of the at least one human with a plurality of pre-stored face image, and determining whether the face image matches at least one pre-stored face image;
in response that the face image does not match any pre-stored face image, issue the alarm for theft; and
in response that the face image matches at least one pre-stored face image and the environment data of the internal of the vehicle does not meet the preset threshold, issue the alarm for help.

13. The electronic device according to claim 12, wherein the at least one processor is further caused to:
in response that at least one animal is determined to be inside the vehicle by the biometric recognition method, and the environment data of the internal of the vehicle does not meet the preset threshold, issue the alarm for help.

14. The electronic device according to claim 9, wherein the at least one processor is further caused to:
in response that the oxygen concentration is less than a first preset threshold, and/or the carbon dioxide concentration is greater than a second preset threshold, and/or the carbon monoxide concentration is greater than a third preset threshold, and/or the temperature is greater than a fourth preset threshold, issue the first alarm.

15. A computer-readable storage medium having instructions stored thereon, when the instructions are executed by a processor of an electronic device, the processor is configured to perform a method for monitoring internal environment of a vehicle, wherein the method comprises:
detecting environment data of internal of the vehicle, and detecting whether an engine of the vehicle is running;
in response that the engine of the vehicle is running and the environment data does not meet a preset threshold, issuing a first alarm;
in response that the engine of the vehicle is not running, obtaining location information of the vehicle, activating a camera device inside the vehicle to capture images or shoot a video of internal of the vehicle, and determining whether at least one living creature is inside the vehicle based on the images or video of the internal of the vehicle;
in response that the at least one living creature is inside the vehicle, transmitting the location information, and the images or the video and the environment data of the internal of the vehicle to a terminal device; and
displaying the location information, the images or the video and the environment data of the internal of the vehicle, and issuing a second alarm in response to a user operation.

16. The storage medium according to claim 15, wherein the environment data comprises oxygen concentration, carbon dioxide concentration, carbon monoxide concentration, and temperature.

17. The storage medium according to claim 15, wherein determining whether at least one living creature is inside the vehicle based on the images or video of the internal of the vehicle comprises:
analyzing the images or video of the internal of the vehicle by using a biometric recognition method.

18. The storage medium according to claim 15, wherein issuing a second alarm in response to a user operation comprises:
receiving a first user operation, and issuing an alarm for theft in response to the first user operation; and
receiving the second user operation, and controlling the vehicle to issue an alarm for help in response to the second user operation.

19. The storage medium according to claim 18, wherein the method further comprises:
in response that at least one human is inside the vehicle by the biometric recognition method, obtaining a face image of the at least one human from the images or video inside the vehicle, comparing a face image of the at least one human with a plurality of pre-stored face image, and determining whether the face image matches at least one pre-stored face image;
in response that the face image does not match any pre-stored face image, issuing the alarm for theft; and
in response that the face image matches at least one pre-stored face image and the environment data of the internal of the vehicle does not meet the preset threshold, issuing the alarm for help.

20. The storage medium according to claim 19, wherein the method further comprises:
in response that at least one animal is determined to be inside the vehicle by the biometric recognition method, and the environment data of the internal of the vehicle does not meet the preset threshold, issuing the alarm for help.
